(19) United States
(12) Patent Application Publication
(10) Pub. No.: US 2025/0383909 A1
(43) Pub. Date: Dec. 18, 2025

(54) SIMULATION DEVICE AND METHOD FOR DIGITAL TWIN-BASED VIRTUAL ENVIRONMENT

(71) Applicants: HYUNDAI MOTOR COMPANY, Seoul (KR); KIA CORPORATION, Seoul (KR)

(72) Inventor: Jong Ho SHIN, Hwaseong-si (KR)

(21) Appl. No.: 18/958,469

(22) Filed: Nov. 25, 2024

(30) Foreign Application Priority Data
Jun. 14, 2024 (KR) 10-2024-0077752

(51) Int. Cl. G06F 9/455

(52) U.S. Cl. CPC G06F 9/45558; G06F 2009/4557

(57) ABSTRACT

A simulation device for a digital twin-based virtual environment includes an input unit for inputting information required for constructing and simulating a virtual environment for a production facility, a memory including an object library for each of a plurality of objects to be disposed in a digital twin (DT)-based virtual space, a DT control unit performing DT simulation on the DT-based virtual environment constructed based on the object library, and an output unit outputting a simulation execution result. The DT control unit includes a DT virtual environment construction unit constructing the DT-based virtual environment, a DT simulation setup unit setting DT simulation setup information on the virtual environment, and a DT simulation execution unit executing a simulation on a target object in the virtual environment, based on a random number generated according to a number of predefined simulation settings and probability, based on the simulation setup information.

### CROSS-REFERENCE TO RELATED APPLICATION(S)

This application claims benefit of priority to Korean Patent Application No. 10-2024-0077752 filed on Jun. 14, 2024 in the Korean Intellectual Property Office, the disclosure of which is incorporated herein by reference in its entirety.

### TECHNICAL FIELD

The present disclosure relates to a simulation device and method for a digital twin-based virtual environment, applicable to production facilities for automobiles and allowing for improved accuracy.

### BACKGROUND

In general, digital twin (DT) technology refers to the creation of a virtual model that mirrors a real-world object within a digital space, allowing for verification through simulations. This technology is being utilized or explored in various sectors, including industrial manufacturing or assembly lines.

Digital twin technology is also being applied to automobile assembly lines, where virtual models can be tested in simulated environments to evaluate different scenarios before actual implementation.

However, current digital twin systems in automobile assembly and production lines face challenges, such as small positional discrepancies between the virtual models and real equipment. These discrepancies can reduce the reliability and accuracy of simulations, requiring additional man-hours during the transition from simulation to actual construction.

Although efforts have been made to improve the alignment between virtual models and real-world equipment by using high-precision measurement tools and advanced techniques during installation, existing simulation methods still struggle to fully eliminate positional errors due to various environmental and technical constraints.

### SUMMARY

An aspect of the present disclosure is to provide a simulation device and method for a digital twin-based virtual environment, in which random numbers defined by different probability distribution functions according to characteristics of respective parameters may be generated a predetermined number of generation times, with respect to physical parameters having a dispersion between a DT-based virtual environment and an actual environment for production facilities such as automobiles, and a result value by statistical probability may be derived by repeatedly performing a simulation based on the generated random numbers.

According to an aspect of the present disclosure, a simulation device for a digital twin-based virtual environment includes an input unit configured to input information required for constructing and simulating a virtual environment for a production facility based on a digital twin (DT); a memory including an object library for each of a plurality of objects to be disposed in a virtual space of the DT-based virtual environment; a DT control unit configured to construct the DT-based virtual environment based on the object library and performing DT simulation on the DT-based virtual environment constructed; and an output unit outputting a simulation execution result. The DT control unit includes a DT virtual environment construction unit configured to construct the DT-based virtual environment based on virtual environment setup information and the object library; a DT simulation setup unit configured to set simulation setup information required for the DT simulation on the virtual environment constructed; and a DT simulation execution unit configured to generate a random number based on the simulation setup information, according to a number of predefined simulation settings and probability for physical parameters of a target object in the virtual environment, and executing a simulation on the target object based on the random number and calculating a simulation result value.

The DT simulation execution unit may be configured to include a random number generation unit generating the random number by a number of predefined random number generation times (N), based on the virtual environment setup information and the simulation setup information, according to a predefined random number generation condition for the physical parameters of the target object in the virtual environment; a simulation execution unit fixing the virtual environment based on the random number, executing a simulation according to a motion sequence by an emulator of a target object in a fixed virtual environment, and calculating a conditional result value according to execution of the simulation; and a result logging unit logging a simulation result value provided by the simulation execution unit to a database after the simulation is executed for the number of simulation settings corresponding to the number of predefined random number generation times (N).

The physical parameters for the target object may be physical elements for each component having an installation distribution for the target object in a setup process of the DT-based virtual environment and a production distribution for the target object in a setup process of the simulation, and may be provided as at least one of a position, a rotation, a height, a size, and an environmental factor.

The object library may be configured to include a basic tolerance range set in advance for the physical parameters for the target object.

The object library may be configured to include a random number generation distribution for each of the physical parameters defined in advance according to characteristics of the target object, as the predefined random number generation condition of the random number generation unit.

The random number generation distribution of the random number generation condition may be a probability distribution function having different dispersions depending on characteristics of each target object.

The number of random number generation times of the random number generation unit (431) may be configured to be determined according to a number of installation random number generation times determined within an installation tolerance range (center reference position value±error) set in consideration of an installation distribution in a setup process of the DT-based virtual environment and a number of production random number generation times determined within a production tolerance range (center reference position value±error) set in consideration of a production distribution in a setup process of the simulation.

The DT virtual environment construction unit may be configured to use an auto-scaling technique automatically adjusting a size ratio of objects in the virtual environment when constructing the virtual environment.

The DT virtual environment construction unit may be configured to use an auto-snapping technique in which the target object is automatically connected to a surrounding structure within the virtual environment when constructing the virtual environment.

The DT simulation setup unit may be configured to use a graphic screen for component parts provided when selecting the target object through a setup GUI of the simulation to set up the target object required for the DT simulation, and may be configured to set a user's selection content for a tolerance range (center reference position±error) for each physical parameter for each of the component parts.

According to an aspect of the present disclosure, a simulation method for a digital twin-based virtual environment includes a digital twin virtual environment construction operation of constructing a virtual environment based on a digital twin (DT), based on virtual environment setup information for a production facility based on the DT and a pre-prepared object library; a DT simulation setup operation of setting simulation setup information required for DT simulation for a constructed virtual environment; and a DT simulation execution operation of generating a random number based on the simulation setup information, according to a predefined number of simulation settings and probability, with respect to physical parameters of a target object in the virtual environment, executing a simulation for the target object based on the random number, and calculating a simulation result value.

The DT simulation execution operation may be configured to include a random number generation operation of generating the random number by a predefined number of random number generation times (N) based on the virtual environment setup information and the simulation setup information, according to a predefined random number generation condition for the physical parameters of the target object in the virtual environment; a simulation execution operation of fixing the virtual environment based on the random number, executing the simulation by an emulator of the target object in the fixed virtual environment according to a motion sequence, and calculating a conditional result value according to execution of the simulation; a simulation execution count determination operation of determining whether the simulation execution has progressed by the number of random number generation times, and proceeding to the random number generation operation when the simulation execution has not progressed by the number of random number generation times; and a result logging operation of logging the simulation result value provided by the simulation execution unit to a database after the simulation is executed by the number of simulation settings corresponding to the number of random number generation times.

The physical parameters for the target object may be physical elements for respective components an having installation distribution for the target object in a virtual environment setup process based on the DT and a production distribution for the target object in a setup process of the simulation, and may be configured as at least one of a position, rotation, a height, a size, and environmental factors.

The object library may be configured to include a basic tolerance range set in advance for the physical parameters for the target object.

The object library may be configured to include a random number generation distribution for each of the physical parameters defined in advance according to characteristics of the target object, as the random number generation condition of the random number generation unit.

A random number generation distribution of the random number generation condition may be a probability distribution function having different dispersions depending on characteristics of each target object.

The random number generation condition may be configured to include a random number generation range having a random number reference value and a design tolerance for each item of the target object.

The DT virtual environment construction operation may be configured to use an auto-scaling technique automatically adjusting a size ratio of objects in the virtual environment when constructing the virtual environment.

The DT virtual environment construction operation may be configured to use an auto-snapping technique in which the target object is connected to surrounding structures in the virtual environment when constructing the virtual environment.

The simulation setup operation may be configured to use a graphic screen for components provided when selecting the target object through a setup GUI of the simulation to set up the target object required for the DT simulation, and may be configured to set a user's selection content for a tolerance range (center reference position±error) for each physical parameter for each of the components.

In addition, aspects of the present disclosure are not limited to the aspects exemplified above, and other aspects may be additionally understood in the process described below.

### BRIEF DESCRIPTION OF DRAWINGS

FIG. 1 is a diagram illustrating an example of a simulation device for a digital twin-based virtual environment.

FIG. 2 is a diagram illustrating an example of a DT simulation execution unit.

FIG. 3 is a diagram illustrating an example of a physical element having an installation distribution for a target object in a virtual environment setup process.

FIG. 4 is a diagram illustrating an example of a physical element having a production distribution for a target object in a simulation setup process.

FIG. 5 is a diagram illustrating an example of an environmental element among physical elements having a distribution.

FIG. 6 is a diagram illustrating an example of a basic tolerance range for physical parameters included in an object library.

FIG. 7 is a diagram illustrating an example of a random number generation distribution for physical parameters included in an object library.

FIG. 8 is a diagram illustrating an example of the number of installation random number generation times considering the installation distribution in a virtual environment setup.

FIG. 9 is a diagram illustrating an example of the number of production random number generation times considering a production distribution in a simulation setup.

FIG. 10 is a diagram illustrating an example of the number of random number settings of a random number generation unit.

FIG. 11 is a diagram illustrating an example of drag & drop applied when constructing a DT virtual environment.

FIG. 12 is a diagram illustrating an example of an auto scaling technique applied when constructing a DT virtual environment.

FIG. 13 is a diagram illustrating an example of an auto snapping technique applied when constructing a DT virtual environment.

FIG. 14 is a diagram illustrating an example of a robot setup among simulation setups.

FIG. 15 is a diagram illustrating an example of a transporter setup among simulation setups.

FIG. 16 is a flowchart illustrating an example of a simulation method for a digital twin-based virtual environment.

FIG. 17 is a diagram illustrating an example of a DT simulation execution operation.

### DETAILED DESCRIPTION

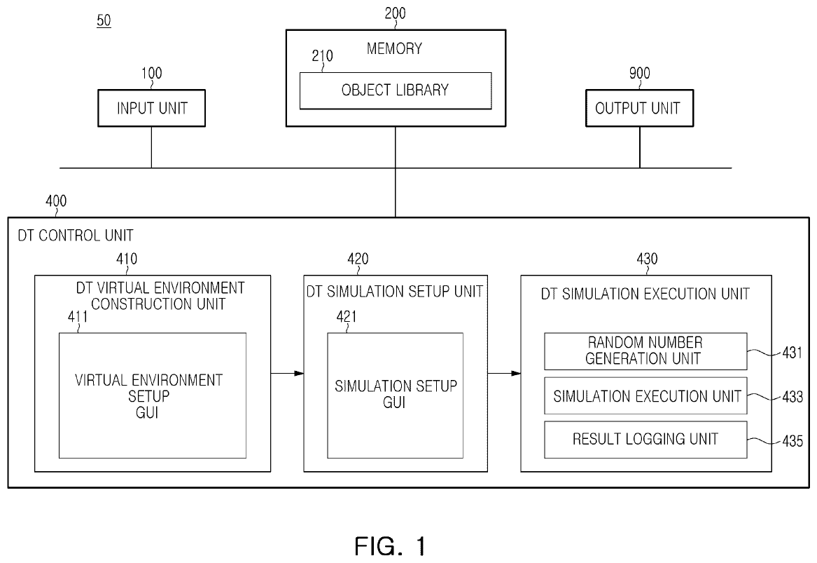

FIG. 1 is a diagram illustrating an example of a simulation device for a virtual environment based on a digital twin.

Referring to FIG. 1, a simulation device 50 for a digital twin-based virtual environment can include an input unit 100, a memory 200, a DT control unit 400, and an output unit 900.

The input unit 100 may input information required for constructing and simulating a virtual environment for a digital twin (DT)-based automobile production facility.

The memory 200 can include an object library 210 for each of a plurality of objects to be disposed in the virtual space of the DT-based virtual environment. For example, objects disposed in the three-dimensional virtual space of the virtual environment can be robots, structures, vision modules, target parts and the like, and more detailed examples can include multi-axis robots of real facilities, facilities with actuators, sensors, transport facilities, assembly parts, assembly targets, jigs for holding assembly targets, and structures for fixing facilities, but are not limited thereto.

In some implementations, The memory 200 can be configured to store computer-executable instructions or program codes, program data, and/or other suitable forms of information. The program stored in the memory 200 can include a set of instructions executable by the processor. In some implementations, the memory 200 may be volatile memory such as random access memory, nonvolatile memory, or a suitable combination thereof, one or more magnetic disk storage devices, optical disk storage devices, flash memory devices, other forms of storage media that may be accessed by the simulation device 50 for a digital twin-based virtual environment and store required information, or a suitable combination thereof.

The DT control unit 400 can construct the DT-based virtual environment based on the object library 210 and perform DT simulation on the constructed DT-based virtual environment.

In the present disclosure, the DT control unit 400 can include at least one processor, and the processor can cause the simulation device 50 for a digital twin-based virtual environment to operate. For example, the processor can execute one or more programs stored in the memory 200. The one or more programs can include one or more computer-executable instructions, and the computer-executable instructions can be configured to cause the simulation device 50 for a digital twin-based virtual environment to perform operations when executed by the processor.

In addition, the DT control unit 400 and the memory 200 can each be implemented as one processor, or the DT control unit 400 and the memory 200 may be implemented by being integrated into one processor.

The output unit 900 can output the simulation execution results. For example, the simulation results output through the output unit 900 can be in the form of DT graphics, which can then be used as user settings within the virtual environment. For example, the simulation result values can be provided in the same form as the quality parameters of the process, and can be intermediate outputs or results, if necessary.

For example, the input unit 100 and the output unit 900 can include individual input interfaces and individual output interfaces, or can include an integrated input/output interface, and for example, can be a user interface in the form of a touch screen capable of touch input and graphic screen output. Examples of input/output interfaces may include input devices such as pointing devices (such as a mouse or trackpad), keyboards, touch input devices (such as a touchpad or touchscreen), voice or sound input devices, various types of sensor devices, and/or photographing devices, and/or output devices such as display devices, printers, speakers, and/or network cards.

For example, the DT control unit 400 can include a DT virtual environment construction unit 410, a DT simulation setup unit 420, and a DT simulation execution unit 430.

The DT virtual environment construction unit 410 can construct a DT-based virtual environment based on the virtual environment setup information and the object library 210.

The DT simulation setup unit 420 can set simulation setup information required for DT simulation for the constructed virtual environment.

The DT simulation execution unit 430 can generate a random number based on the simulation setup information, according to the predefined simulation setup number and probability for the physical parameters of the target object in the virtual environment, and execute a simulation for the target object based on the random number to calculate a simulation result value.

The exact position of the target object described above may not be defined, but a tolerance range can be defined based on the statistical probability according to the distribution for respective parameters having a distribution.

In the present disclosure, the DT virtual environment construction unit 410, the DT simulation setup unit 420, and the DT simulation execution unit 430 can be implemented as hardware or software or a combination thereof in at least one integrated circuit (IC) built into the DT control unit 400, and are not particularly limited to any one.

For respective drawings in the present disclosure, unnecessary redundant descriptions of components with the same symbol and the same function may be omitted, and possible differences may be described for respective drawings.

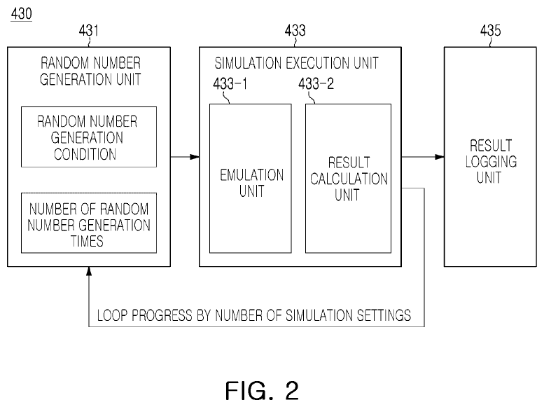

FIG. 2 is an example diagram of the DT simulation execution unit.

Referring to FIG. 2, the DT simulation execution unit 430 can include a random number generation unit 431, a simulation execution unit 433, and a result logging unit 435.

The random number generation unit 431 can generate a random number by a predefined number of random number generation times (N) based on the virtual environment setup information and the simulation setup information, according to the predefined random number generation conditions for the physical parameters of the target object in the virtual environment. For example, the random number generation unit 431 can generate a random number having the same format as the signal or data of various facilities.

The simulation execution unit 433 can include, for example, an emulation unit 433-1 and a result calculation unit 433-2.

The emulation unit 433-1 can adjust the virtual environment based on the random number, and execute a simulation in which the emulator of the target object in the adjusted virtual environment operates the object similarly to the real thing in the virtual environment according to a motion sequence. The result calculation unit 433-2 can calculate a result value for each condition according to the simulation execution. Accordingly, in the simulation execution unit 433, the conditional result value can be a defect occurrence rate for each generated random number, but is not limited thereto, and can be at least one of pieces of information that can be derived according to the simulation execution.

The result logging unit 435 can store or log the simulation result value by the simulation execution unit 433 at a database (DB) after the simulation is executed for the number of simulation settings corresponding to the number of random number generation times (N). In this case, the database (DB) can be provided inside or outside the simulation device 50 for a digital twin-based virtual environment.

Hereinafter, the present disclosure is described for installation distribution and production distribution, but is not limited thereto, and if it includes installation distribution and production distribution, other additional distributions may be further considered.

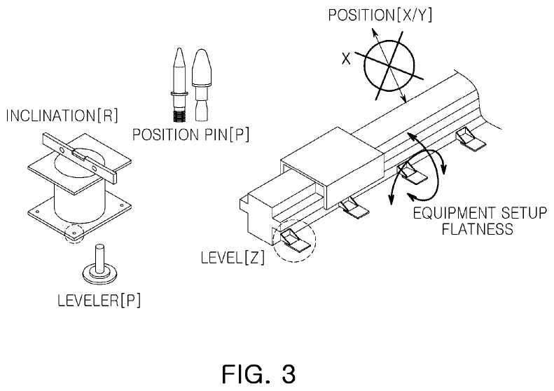

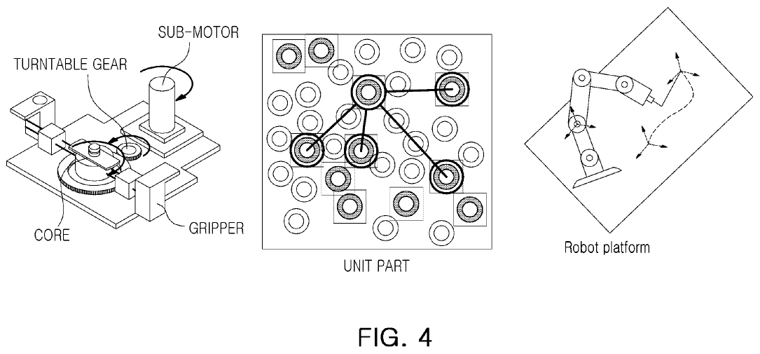

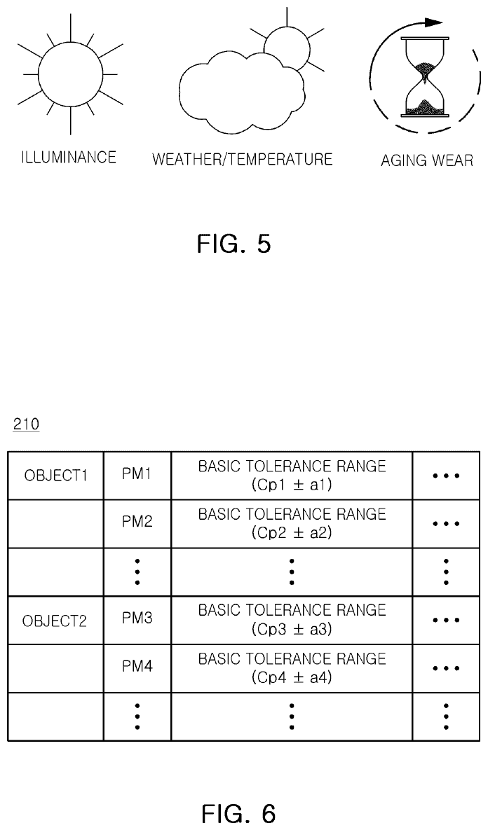

FIG. 3 is an example diagram of a physical element having an installation distribution for a target object in a virtual environment setup process, FIG. 4 is an example diagram of a physical element having a production distribution for a target object in a simulation setup process, and FIG. 5 is an example diagram of an environmental element among physical elements having a distribution.

Referring to FIGS. 3-5, the physical parameters for the target object may be physical elements for respective components having an installation distribution (see FIG. 3) for the target object in the DT-based virtual environment setup process, and can also be physical elements for respective components having a production distribution (see FIG. 4) for the target object in the simulation setup process.

For example, the physical parameters for the object can be at least one of position, rotation, height, size, or environmental factors (see FIG. 5).

Referring to FIG. 3, among the physical parameters for each component having an installation distribution for the target object in the virtual environment setup process, variable parameters of the fixture such as the fixed fixture and the fixed position pin may be the leveler height [P], the inclination of the robot base [R], the position of the position pin [P], the position of the equipment [X/Y], flatness, and level [Z], or the like. In this case, [P] is a rotation identification factor, [X/Y], [Z] and [P] are coordinate position identification factors, and [R] may be a rotation identification factor, and through these identification factors, the DT control unit 400 may identify the parameter type.

Referring to FIG. 4, in the production distribution for the target object in the simulation setup process, there may be a control/equipment deviation of a drive unit such as a robot and a component design/manufacturing distribution, and for example, the production distribution may include a unit component distribution, a facility mechanism distribution, a component loading distribution, a robot axis-control distribution, a design/manufacturing distribution, and the like. For example, physical parameters for each component having a production distribution may be core, gripper, turntable, sub-motor, unit part, robot platform, and the like.

Referring to FIG. 5, among the physical parameters for the object, environmental factors may be illuminance, weather/temperature, aging wear and the like. For example, among environmental factors, for optical elements such as vision lighting, indoor lighting, and natural light, a simulation may be performed by generating random numbers for optical effects such as position/direction, color/intensity/range, and shadows.

In addition, in the case in which the target object is a vision sensor, there are cases where the determination result varies in reality due to optical elements such as diffuse reflection, illuminance conditions, and object texture. In response to such cases, in relation to the material and rendering options for the optical elements, if necessary, the material, color, texture, and roughness of the target object may be set and added to the random number management items, and accordingly, the rendering prediction may be confirmed and used as graphic parameters for random number generation when producing image videos.

FIG. 6 is an example of a basic tolerance range for physical parameters PM1, PM2, . . . included in an object library.

Referring to FIG. 6, the object library 210 may include a basic tolerance range cpta preset for physical parameters PM1, PM2, . . . for the target object. For example, when the basic tolerance range is ‘cpta’, cp may be a center position (or a center reference position) and a may be an allowable error. For example, as illustrated in FIG. 6, when there are two first parameter PM1, second parameter PM2, third parameter PM2 and fourth parameter PM4, the first parameter PM1 may have a basic tolerance range of ‘cp1±a1’, the second parameter PM2 may have a basic tolerance range of ‘cp2±a2’, the third parameter PM3 may have a basic tolerance range of ‘cp3±a3’, and the fourth parameter PM4 may have a basic tolerance range of ‘cp4±a4’.

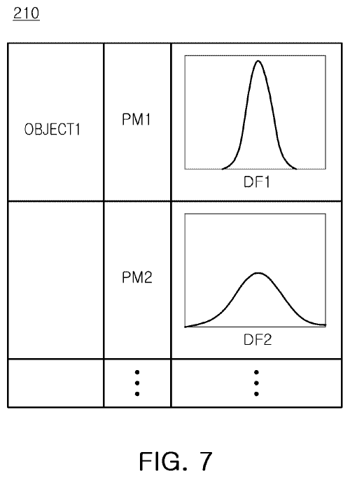

FIG. 7 is an example of a random number generation distribution for physical parameters included in an object library.

Referring to FIG. 7, the object library 210 may include a random number generation distribution defined separately for each of the physical parameters, for example, PM1 and PM2, defined in advance according to the characteristics of the target object, as a random number generation condition of the random number generation unit 431.

The random number generation distribution of the random number generation condition may be defined in advance as a probability distribution function having different dispersions according to characteristics of respective target objects.

For example, the distribution function illustrated in FIG. 7 may be a concentrated distribution function DF1 or a normal distribution function DF2, but is not limited thereto, and may be defined according to the dispersion characteristics of the corresponding object.

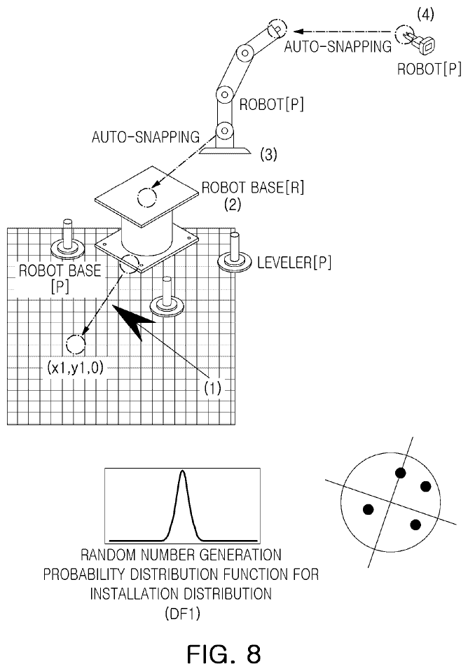

FIG. 8 is an example diagram illustrating the number of installation random number generation times considering the installation distribution in a virtual environment setup, and

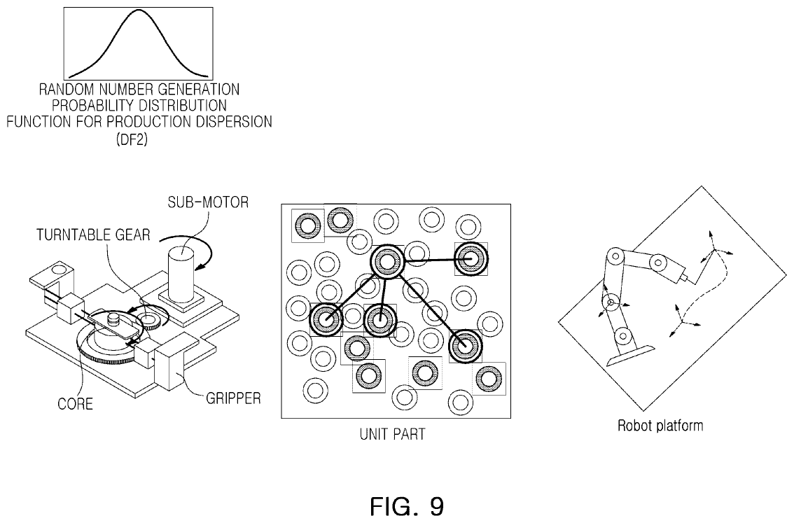

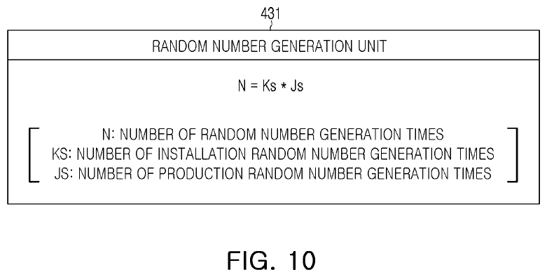

FIG. 9 is an example diagram illustrating the number of production random number generation times considering the production distribution in a simulation setup. FIG. 10 is an example of the number of random number settings of the random number generation unit.

Referring to FIG. 8, the number of random number generation times (N) of the random number generation unit 431 may be calculated based on the number of installation random number generation times (Ks) determined in the installation tolerance range (center reference position value (Cp)±tolerance (a)) set in consideration of the installation distribution in the virtual environment setup process based on the DT.

In FIG. 8, the probability distribution function for random number generation with respect to the installation distribution may be a concentrated probability distribution function DF1, and based on this concentrated probability distribution function DF1, kinematic repeatability random number generation may be performed in consideration of the production distribution.

Referring to (1) of FIG. 8, a target object may be disposed in a position by drag & drop based on the user grid. Referring to (2) of FIG. 8, for the drag & drop position, the robot base position, the robot base rotation and the leveler position, default tolerance information based on user-defined positions may be automatically generated and included in the object library as described above, and this tolerance information may be changed, and a distribution may be generated by a random combination of parameters (for example, leveler height, robot base inclination, and the like) of each component. Referring to (3) of FIG. 8, the auto-snapping is performed to the robot base center point, but the setup distribution position (X, Y) may be randomly generated. In addition, referring to (4) of FIG. 8, the auto-snapping is performed based on the robot TCP, but the setup distribution may be randomly generated.

Referring to FIG. 9, the number of random number generation times (N) of the random number generation unit 431 may be calculated based on the number of production random number generation times (Js) determined in the production tolerance range (center reference position value±error) set in consideration of the production distribution in the simulation setup process.

In FIG. 9, the probability distribution function for random number generation with respect to the production distribution may be a normal probability distribution function DF2, and random number generation considering the production distribution may be performed based on this normal probability distribution function DF2.

In FIG. 9, as an example, the physical parameters for each component having the production distribution may be a core, a gripper, a turntable, a sub-motor, a unit part, a robot platform, and the like.

Referring to FIG. 10, the number of times (N) random numbers of the random number generation unit 431 are generated may be calculated using the number of times (Ks) installed random numbers are generated and the number of times (Js) produced random numbers are generated. For example, the number of times (N) random numbers of the random number generation unit 431 are generated may be determined by multiplying the number of times (Ks) installed random numbers are generated and the number of times (Js) produced random numbers are generated. This example is only one example of calculating the number of times (N) random numbers are generated, and therefore, the present disclosure is not limited thereto.

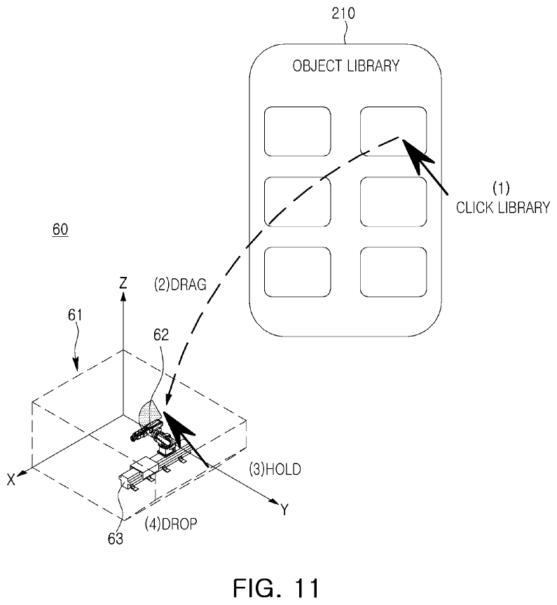

FIG. 11 is an example diagram illustrating drag & drop applied when constructing a DT virtual environment.

Referring to FIG. 11, a DT virtual environment 60 may be defined by a 3D scene 61 defining a process space, objects 62 defined in the object library 210, and constructed digital 3D facility assets 63 defined through a separate layer.

In the object library 210 of FIG. 11, an interface available in the transmission medium to a required position within the 3D scene 61 may be a device such as a mouse, touch drag, or hand tracking motion recognition, and the method of placing the target object from the object library 210 to a required position within the 3D scene 61 may be a drag-hold-drop method.

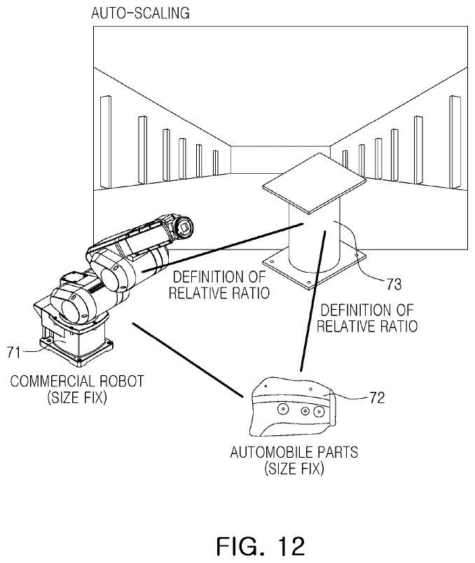

FIG. 12 is an example diagram illustrating the auto scaling technique applied when constructing the DT virtual environment.

Referring to FIGS. 11 and 12, the DT virtual environment construction unit (410, see FIG. 1) may use the auto scaling technique to automatically adjust the size ratio of the objects of the virtual environment when constructing the virtual environment.

For example, a commercial robot 71 and automobile parts 72 required in the automobile assembly process are predefined in relative ratio based on a basic object 73 such as the robot base, as a reference, but there may be cases where the overall size ratio does not match during the construction of the virtual environment for various reasons. In this case, if one object is set as a reference and the corresponding magnification is input, the auto scaling technique may be applied based on the reference object to automatically scale the overall size ratio. Accordingly, the resolution between objects in the virtual environment may be automatically adjusted, so that the consistency between the virtual environment and the real object may be improved during the process of constructing the virtual environment. This auto-scaling technique is applied to objects defined as size variability, and objects not defined as variability may not be affected.

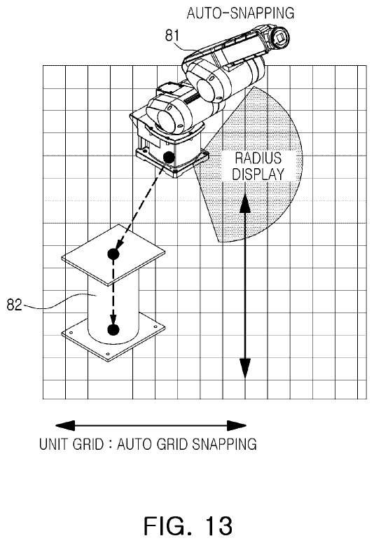

FIG. 13 is an example diagram illustrating the auto-snapping technique applied when constructing the DT virtual environment.

Referring to FIGS. 11 and 13, the DT virtual environment construction unit 410 may use the auto-snapping technique in which the target object is automatically connected to the surrounding structures in the virtual environment when constructing the virtual environment.

For example, when the virtual space used in the automobile assembly process is composed of grid units for the convenience of layout, the auto-grid snapping technique may be used. For example, when a robot 81 is disposed in a required position in a virtual space, for example, by dragging and dropping, and the auto grid snapping technique is applied, the robot 81 may be automatically connected to and disposed in another object, for example, equipment such as a robot base 82, that is disposed in advance in the space to be disposed. For example, when the robot 81 is disposed, the physical parameters of the robot 81 may be displayed, and also the motion radius of the robot 81 may be displayed.

In this disclosure, when placing a target object in a virtual space, if the virtual space is composed of grid units, snapping is basically performed in grid units, but objects defined as auto snapping center points Cp may be auto snapped and positions thereof may be determined thereafter.

Meanwhile, after placing a target object in a virtual space, child objects such s fixed objects, for example, levelers, shims and anchors, which may be practically necessary and be automatically defined, may have the tolerance with the same preset default value and random number generation format, which are applied thereto.

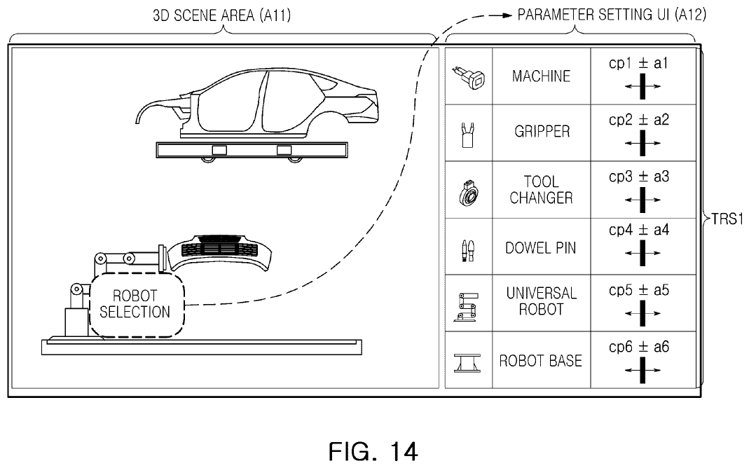

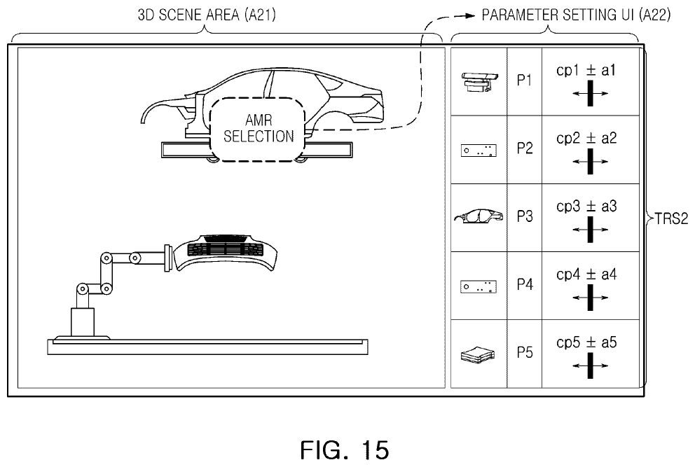

FIG. 14 is an example of a robot setup among simulation setups, and FIG. 15 is an example of a transport setup among simulation setups.

Referring to FIGS. 14 and 15, the DT simulation setup unit 420 may set the user's selection content for the tolerance range (center reference position±error) for each physical parameter of each component by using the graphic screen for the component provided when selecting the target object for the setup of the target object (multi-axis robot or transporter) required for the DT simulation through the simulation setup GUI 421.

Referring to FIG. 14, the DT simulation setup unit 420 (see FIG. 1) may output, through the simulation setup GUI 421, a 3D scene area A11 of a virtual environment in which the target object is disposed and a parameter setting UI A12 for simulation setup for a multi-axis robot, which is one of the target objects required for the DT simulation, as illustrated in FIG. 14, and the parameter setting UI A12 may display a tolerance range as described above for each detailed item of the robot, which is the target object, and this tolerance range may be adjusted.

For example, when setting up a simulation after constructing a virtual environment, if a robot including a set of components including a machine, a gripper, a tool changer, a dowel pin, a universal robot, and a robot base is selected, the component set is provided through the graphic screen TRS1 in the parameter setting UI A12, so that the user may set the tolerance range for each physical parameter (center reference position (Cpk)±error (ak), k=1 to 6 (k is the number of components)) for each of the above components by using the 3D scene area A11 and the parameter setting UI A12, and therefore, the user may set the tolerance range of each component again.

For example, if a set of components includes six components, namely a machine, a gripper, a tool changer, a dowel pin, a universal robot, and a robot base, respective tolerance ranges Cp1±a1, Cp2±a2, Cp3±a3, Cp4±a4, Cp5±a5, and Cp6±a6 are provided, and the user may set these tolerance ranges for respective components.

Referring to FIG. 15, the DT simulation setup unit (420, see FIG. 1) may output, through the simulation setup GUI 421, a 3D scene area A21 of a virtual environment in which the target object is disposed and a parameter setting UI A22, for simulation setup for a transporter (AMR: Autonomous Mobile Robots), which is one of the target objects required for the DT simulation, as illustrated in FIG. 15, and the parameter setting UI A22 may display a tolerance range as described above for each detailed item of the transporter, which is the target object, and may adjust this tolerance range. For example, the transporter AMR may be an unmanned transport robot including a body-in-white (BIW).

For example, when setting up a simulation after constructing a virtual environment, if a transporter AMR including a set of components including multiple components P1, P2, P3, P4 and P5 is selected, the component set is provided through the graphic screen TRS2 in the parameter setting UI A22 so that the user may set the tolerance range for each physical parameter (center reference position (Cpk)±error (ak), k=1 to 5 (k being the number of components)) for each of the components by using the 3D scene area A21 and the parameter setting UI A22, and therefore, the user may set the tolerance range of each component.

For example, in the case in which a set of components includes five components P1, P2, P3, P4 and P5, respective tolerance ranges Cp1±a1, Cp2±a2, Cp3±a3, Cp4±a4 and Cp5±a5 are presented, and the user may set these tolerance ranges for respective components. For example, five components P1, P2, P3, P4 and P5 may be, but are not limited to, parts assembly department shape, assembly part reference shape, car body, floor reference hole, and body transport AMR.

Meanwhile, when setting up a simulation after constructing a virtual environment, an unmanned transfer robot for transferring the body-in-white (BIW) corresponding to the vehicle frame in the simulation device is defined as the transporter AMR, and in the case in which an assembly target (for example, BIW) and a part to be assembled are present on the transporter AMR, the transporter AMR follows a preset simulation rule for production distribution, and the component to be assembled may reflect a preset default tolerance or a previous tolerance, and for example, if there is no default tolerance, a notification for specifying a tolerance may be given if necessary.

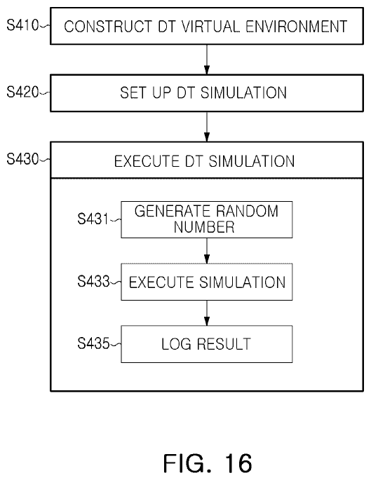

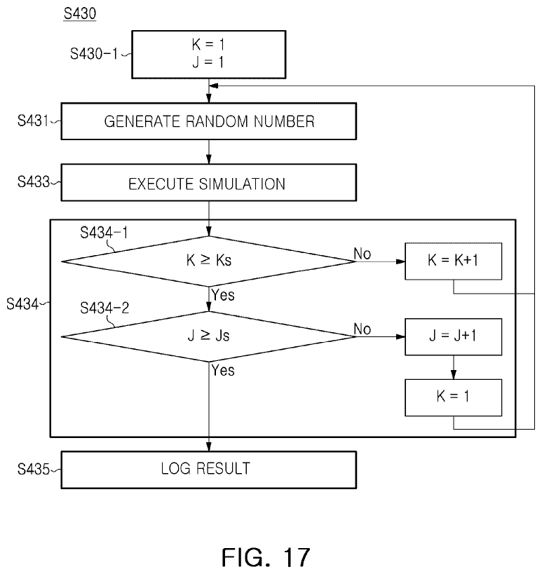

Hereinafter, with reference to FIGS. 16 and 17, a method for simulating a digital twin-based virtual environment will be described. In the present disclosure, the description of the method for simulating a digital twin-based virtual environment and the description of the simulation device for a digital twin-based virtual environment may be applied in a complementary or common manner, unless they are mutually exclusive. Accordingly, overlapping descriptions may be omitted.

For example, the simulation method for the DT-based virtual environment can be executed by the simulation device 50 for a DT-based virtual environment described with reference to FIGS. 1 to 15, and the main process of the simulation method for the digital twin-based virtual environment is described below.

FIG. 16 is a flowchart illustrating the simulation method for the digital twin-based virtual environment.

Referring to FIGS. 1 and 16, the simulation method for the digital twin-based virtual environment can include a DT virtual environment construction operation (S410), a DT simulation setup operation (S420), and a DT simulation execution operation (S430).

In the DT virtual environment construction operation (S410), the simulation device 50 for a DT-based virtual environment can construct the DT-based virtual environment based on the virtual environment setup information for the automobile production facility based on the digital twin (DT) and the object library prepared in advance.

In the DT simulation setup operation (S420), the simulation device 50 for a DT-based virtual environment can set the simulation setup information necessary for the DT simulation for the constructed virtual environment.

In the DT simulation execution operation (S430), the simulation device 50 for a DT-based virtual environment can generate a random number according to the number of simulation settings and probability defined in advance, with respect to the physical parameters of the target object in the virtual environment, based on the simulation setup information, and execute the simulation for the target object, based on the random number, thereby calculating the simulation result value.

FIG. 17 is a diagram illustrating an example of the DT simulation execution operation.

Referring to FIG. 17, the DT simulation execution operation (S430) can include an initialization operation (S430-1), a random number generation operation (S431), a simulation execution operation (S433), a simulation execution count determination operation (S434), and a result logging operation (S435).

In the initialization operation (S430-1), the simulation device 50 for a DT-based virtual environment can initialize (K=1, J=1) the necessary variables (K, J) in relation to the number of random number generation times and the number of simulation execution times.

In the random number generation operation (S431), the simulation device 50 for a DT-based virtual environment can generate random numbers by the number of random number generation times (N) predefined according to the random number generation conditions defined for the physical parameters of the target object in the virtual environment, based on the virtual environment setup information and the simulation setup information.

In the simulation execution operation (S433), the virtual environment can be adjusted based on the random number, and the emulator of the target object in the adjusted virtual environment can execute the simulation according to the motion sequence, and the result value for each condition can be calculated according to the simulation execution.

In the simulation execution count determination operation (S434), the simulation device 50 for a DT-based virtual environment can determine whether the simulation execution has proceeded by the number of random number generation times (N), and if the simulation execution has not proceeded by the number of random number generation times (N), it may proceed to the random number generation operation.

For example, the simulation execution count determination operation (S434) can include a first determination operation (S434-1) and a second determination operation (S434-2).

In the first determination operation (S434-1), the simulation device 50 for a DT-based virtual environment can determine whether the currently generated installation random number count (variable, K) is greater than or equal to the number of installation random number generation times (Ks), and if it is not greater than or equal to, the installation random number count (variable, K) can be increased by 1 and proceed to the random number generation operation (S41), and if it is greater than or equal to, the second determination operation (S434-2) can be performed.

In addition, in the second determination operation (S434-2), the simulation device 50 for a DT-based virtual environment can determine whether the number of currently generated production random numbers (variable, J) is greater than or equal to the number of production random number generation times (Js). If it is not greater than or equal to, the number of production random numbers (variable, J) is increased by 1 and the installation random number count (variable, K) is initialized to 1, and the random number generation operation (S41) may be performed. If it is greater than or equal to, the following result logging operation (S435) can be performed.

In the result logging operation (S435), the simulation device 50 for a DT-based virtual environment can store or log the simulation result value by the simulation execution unit 433 at the database (DB) after the simulation is executed by the number of simulation settings corresponding to the number of random number generation times (N).

As described above, the physical parameters for the target object may be at least one of position, rotation, height, size, and environmental factors, as the physical element for each component having an installation distribution for the target object in the DT-based virtual environment setup process and a production distribution for the target object in the simulation setup process. A more detailed description thereof is as described above with reference to FIGS. 3, 4, and 5.

As described above, the object library 210 can include a basic tolerance range that is set in advance for the physical parameters for the target object. A more detailed description thereof is as described above with reference to FIG. 6.

As described above, the object library 210 can include a random number generation distribution for each of the physical parameters defined in advance according to the characteristics of the target object, as a random number generation condition of the random number generation unit 431. In addition, the random number generation distribution of the random number generation condition can be a probability distribution function (normal distribution function or concentrated distribution function) having different dispersions according to the characteristics of respective target objects. A more detailed description thereof is as described above with reference to FIG. 7.

As described above, the random number generation condition can include a random number generation range having a random number reference value and a design tolerance for each item of the target object. A more detailed description thereof is as described above with reference to FIGS. 8, 9, and 10.

As described above, in the DT virtual environment construction operation (S410), the simulation device 50 for a DT-based virtual environment can utilize an auto-scaling technique that automatically adjusts the size ratio of objects in the virtual environment when constructing the virtual environment. A more detailed description thereof is as described above with reference to FIGS. 11 and 12.

As described above, in the DT virtual environment construction operation (S410), the simulation device 50 for a DT-based virtual environment can utilize an auto-snapping technique that automatically connects target objects to surrounding structures in the virtual environment when constructing the virtual environment. A more detailed description thereof is as described above with reference to FIGS. 11 and 13.

As described above, in the simulation setup operation (S420), the simulation device 50 for a DT-based virtual environment can set the user's selection content for the tolerance range for each physical parameter (center reference position±error) for each component, by using the graphic screen for the component provided when selecting the target object, for setup of the target object (multi-axis robot or transporter) required for the DT simulation, through the simulation setup GUI 421. A more detailed description thereof is as described above with reference to FIGS. 14 and 15.

According to the simulation device and method according to the present disclosure as described above, even after the virtual environment is constructed, it is difficult to measure the exact position of the equipment or the process dispersion factors that occur, but since the quality management data may be acquired in the same form as the virtual environment, the simulation consistency may be improved by rechecking and correcting whether there are any problems in the past simulation definition operation or motion sequence based on the corresponding real process data.

As set forth above, random numbers defined by different probability distribution functions according to characteristics of respective parameters may be generated a predetermined number of generation times, with respect to physical parameters having a dispersion between a DT-based virtual environment and an actual environment for automobile production facilities, and a result value by statistical probability may be derived by repeatedly performing a simulation based on the generated random numbers.

By performing the repetitive simulations, the dispersion of physical parameters may be managed periodically and continuously, and positional error between a virtual environment and a real may be reduced. Accordingly, the effect of improving positional consistency may be provided in the application to the design of automobile equipment processes.

What is claimed is:

1. A simulation device for a digital twin-based virtual environment, comprising:
an input unit configured to receive information for constructing and simulating a virtual environment of a production facility based on a digital twin (DT);
a memory configured to store an object library for each of a plurality of objects to be disposed in a virtual space of the DT-based virtual environment;
a DT controller configured to construct the DT-based virtual environment based on the object library and perform DT simulation on the DT-based virtual environment; and
an output unit configured to output a simulation execution result,
wherein the DT controller includes:
a DT virtual environment construction unit configured to construct the DT-based virtual environment based on virtual environment setup information and the object library,
a DT simulation setup unit configured to set simulation setup information for the DT simulation on the virtual environment, and
a DT simulation execution unit configured to:
based on a number of predefined simulation settings and probability for physical parameters of a target object in the virtual environment, generate a random number based on the simulation setup information,
execute a simulation on the target object based on the random number, and
calculate a simulation result value.

2. The simulation device of claim 1, wherein the DT simulation execution unit includes:
a random number generation unit configured to, based on the virtual environment setup information and the simulation setup information, generate the random number by a number of predefined random number generation times (N), according to a predefined random number generation condition for the physical parameters of the target object in the virtual environment,
a simulation execution unit configured to adjust the virtual environment based on the random number, and, in the adjusted virtual environment, (i) execute a simulation according to a motion sequence by an emulator of a target object, and (ii) calculate a conditional result value according to execution of the simulation, and
a result logging unit configured to store a simulation result value provided by the simulation execution unit at a database after the simulation is executed for the number of simulation settings corresponding to the number of predefined random number generation times (N).

3. The simulation device of claim 2, wherein the physical parameters for the target object are (i) physical elements for each component having an installation distribution for the target object in a setup process of the DT-based virtual environment and a production distribution for the target object in a setup process of the simulation and (ii) provided as at least one of a position, a rotation, a height, a size, or an environmental factor.

4. The simulation device of claim 3, wherein the object library includes a basic tolerance range that is set in advance for the physical parameters of the target object.

5. The simulation device of claim 3, wherein the object library includes a random number generation distribution for each of the physical parameters defined in advance according to characteristics of the target object, as the predefined random number generation condition of the random number generation unit.

6. The simulation device of claim 5, wherein the random number generation distribution of the random number generation condition is a probability distribution function having different dispersions depending on characteristics of each target object.

7. The simulation device of claim 2, wherein the number of random number generation times of the random number generation unit is determined based on (i) a number of installation random number generation times determined within an installation tolerance range that is set in consideration of an installation distribution in a setup process of the DT-based virtual environment and (ii) a number of production random number generation times determined within a production tolerance range that is set in consideration of a production distribution in a setup process of the simulation.

8. The simulation device of claim 1, wherein the DT virtual environment construction unit is configured to utilize an auto-scaling technique that automatically adjusts a size ratio of objects in the virtual environment when constructing the virtual environment.

9. The simulation device of claim 1, wherein the DT virtual environment construction unit is configured to utilize an auto-snapping technique in which the target object is automatically connected to a surrounding structure within the virtual environment when constructing the virtual environment.

10. The simulation device of claim 2, wherein the DT simulation setup unit is configured to:
utilize a graphic screen for component parts that is provided when selecting the target object through a setup GUI of the simulation to set up the target object required for the DT simulation, and
set a selection content for a tolerance range for each physical parameter for each of the component parts.

11. A simulation method for a digital twin-based virtual environment, the simulation method comprising:
a digital twin virtual environment construction operation of constructing a virtual environment of a production facility based on a digital twin (DT), virtual environment setup information, and a pre-defined object library;
a DT simulation setup operation of setting simulation setup information for DT simulation of the constructed virtual environment; and
a DT simulation execution operation including:
generating a random number based on the simulation setup information, based on a predefined number of simulation settings and probability for physical parameters of a target object in the virtual environment,
executing a simulation for the target object based on the random number, and
calculating a simulation result value.

12. The simulation method of claim 11, wherein the DT simulation execution operation includes:
a random number generation operation of generating, based on the virtual environment setup information and the simulation setup information, the random number by a predefined number of random number generation times (N), according to a predefined random number generation condition for the physical parameters of the target object in the virtual environment,
a simulation execution operation of adjusting the virtual environment based on the random number, and, in the adjusted virtual environment, (i) executing the simulation by an emulator of the target object according to a motion sequence and (ii) calculating a conditional result value according to execution of the simulation,
a simulation execution count determination operation of determining whether the simulation execution has progressed by the number of random number generation times, and proceeding to the random number generation operation when the simulation execution has not progressed by the number of random number generation times, and
a result logging operation of storing the simulation result value provided by the simulation execution operation at a database after the simulation is executed by the number of simulation settings corresponding to the number of random number generation times.

13. The simulation method of claim 12, wherein the physical parameters for the target object are (i) physical elements for respective components having an installation distribution for the target object in a virtual environment setup process based on the DT and a production distribution for the target object in a setup process of the simulation and (ii) provided as at least one of a position, rotation, a height, a size, or environmental factors.

14. The simulation method of claim 13, wherein the object library includes a basic tolerance range that is set in advance for the physical parameters of the target object.

15. The simulation method of claim 13, wherein the object library includes a random number generation distribution for each of the physical parameters defined in advance according to characteristics of the target object, as the random number generation condition of the random number generation operation.

16. The simulation method of claim 13, wherein a random number generation distribution of the random number generation condition is a probability distribution function having different dispersions depending on characteristics of each target object.

17. The simulation method of claim 12, wherein the random number generation condition includes a random number generation range having a random number reference value and a design tolerance for each item of the target object.

18. The simulation method of claim 11, wherein the DT virtual environment construction operation utilizes an auto-scaling technique that automatically adjusts a size ratio of objects in the virtual environment when constructing the virtual environment.

19. The simulation method of claim 11, wherein the DT virtual environment construction operation utilizes an auto-snapping technique in which the target object is connected to surrounding structures in the virtual environment when constructing the virtual environment.

20. The simulation method of claim 12, wherein the simulation setup operation utilizes a graphic screen for components provided when selecting the target object through a setup GUI of the simulation to set up the target object required for the DT simulation, and sets a selection content for a tolerance range for each physical parameter for each of the components.
